(19) United States
(12) Patent Application Publication
(10) Pub. No.: US 2008/0295803 A1
(43) Pub. Date: Dec. 4, 2008

(54) Camshaft wheel for determining startup engine angle and machine using same

(75) Inventors: Michael Snopko, Lincoln, IL (US); Robert Weber, Dunlap, IL (US)

Correspondence Address: CATERPILLAR c/o LIELL, MCNEIL & HARPER, P.O. BOX 2417, 511 SOUTH MADISON STREET, BLOOMINGTON, IN, 47402-2417, US

(73) Assignee: Caterpillar Inc.

(21) Appl. No.: 11/807,443

(22) Filed: May 29, 2007

(51) Int. Cl. F02P 5/05

(52) U.S. Cl. 123/406.58

(57) ABSTRACT

A machine having an internal combustion engine includes a camshaft wheel rotatably driven by a crankshaft of the engine. The camshaft wheel includes a plurality of circumferentially spaced teeth. A first engine angle indicator is positioned among the circumferentially spaced of the camshaft wheel and is one of a missing tooth and an additional tooth. A second engine angle indicator is positioned among the circumferentially spaced teeth of the camshaft wheel less than about 90 degrees from the first engine angle indicator. The second engine angle indicator is also one of a missing tooth and an additional tooth. A camshaft wheel sensor produces a pulsetrain in response to detection of the plurality of circumferentially spaced teeth and additional teeth. An electronic control module is configured to determine a location of the first engine angle indicator and the second engine angle indicator based on the pulsetrain, and determine a startup engine angle based on a timing separation between features of the pulsetrain.

### TECHNICAL FIELD

The present disclosure relates generally to a camshaft wheel for determining a startup engine angle, and more particularly to a camshaft wheel having at least two engine angle indicators along the perimeter thereof for determining the startup engine angle in less than one rotation of the camshaft wheel.

### BACKGROUND

In electronically controlled fuel injection engines, an electronic control module (ECM) typically controls fuel injection to each cylinder of the engine. The ECM, therefore, needs to know the stroke of each cylinder of the engine to properly control fuel injection and ignition. During engine starting, the ECM must acquire this information before beginning injection.

Typically, the startup engine angle is acquired using crankshaft position information. The crankshaft position information is typically produced using a toothed wheel with at least one angle indicator on the perimeter thereof. The ECM can determine the startup angle of the engine based on the location of the angle indicator. However, since the crankshaft rotates twice per engine cycle, the startup engine angle can only be determined to one of two possibilities. To determine the unique startup engine angle, additional information is used. Typically, information from the camshaft is used to assist in determining this startup angle.

Since the ECM waits for this information to begin fuel injection and, thereafter, ignition, a certain amount of time lapses between when engine starting is initiated and when the engine begins running on its own. It typically takes at least two engine revolutions before this occurs, which leads to increased starting time and decreased customer satisfaction.

Conventional approaches in reducing engine start time include improving the time in which the startup engine angle is acquired. For example, Japanese Publication No. 05133268 includes a method of discriminating the cylinder of the engine within one rotation of a crankshaft. A crankshaft wheel is provided having a plurality of circumferentially spaced teeth and one missing tooth positioned along the perimeter thereof. A camshaft wheel is also provided having a plurality of circumferentially spaced teeth and one additional tooth positioned along the perimeter thereof. Electromagnetic pickups are positioned in close proximity to each wheel and create a signal corresponding to teeth that pass the pickups as the wheels rotate. The extra tooth of the camshaft wheel is positioned so that it corresponds to the missing tooth of the crankshaft wheel every second rotation of the crankshaft. Therefore, after one rotation of the crankshaft, a signal is received for either both the missing tooth and the extra tooth or just the missing tooth to determine engine position. This reference, however, relies upon two target wheels to determine engine position and does not provide verification in case a false missing tooth or false extra tooth is observed.

The present disclosure is directed to one or more of the problems set forth above.

### SUMMARY OF THE INVENTION

In one aspect, a machine having an internal combustion engine includes a camshaft wheel rotatably driven by a crankshaft of the engine. The camshaft wheel includes a plurality of circumferentially spaced teeth. A first engine angle indicator is positioned among the circumferentially spaced of the camshaft wheel and is one of a missing tooth and an additional tooth. A second engine angle indicator is positioned among the circumferentially spaced teeth of the camshaft wheel less than about 90 degrees from the first engine angle indicator. The second engine angle indicator is also one of a missing tooth and an additional tooth. A camshaft wheel sensor produces a pulsetrain in response to detection of the plurality of circumferentially spaced teeth and additional teeth. An electronic control module is configured to determine a location of the first engine angle indicator and the second engine angle indicator based on the pulsetrain, and determine a startup engine angle based on a timing separation between features of the pulsetrain.

In another aspect, a method of determining a startup angle of an internal combustion engine includes a step of rotating the engine prior to combustion. The method also includes a step of producing a pulsetrain in response to detection of a plurality of circumferentially spaced teeth around a perimeter of a camshaft wheel. A first engine angle indicator and a second engine angle indicator are identified from the pulsetrain. The method also includes a step of determining the startup angle of the engine based on a timing separation between features of the pulsetrain.

In another aspect, a camshaft wheel for an internal combustion engine includes a circular wheel having 36 equidistantly spaced teeth locations and at least 33 teeth. A first missing tooth is positioned among the spaced teeth locations of the wheel, and a second missing tooth is positioned among the spaced teeth locations of the wheel less than 90 degrees from the first missing tooth. At least one tooth is positioned between the first missing tooth and the second missing tooth.

### BRIEF DESCRIPTION OF THE DRAWINGS

FIG. 1 is a schematic diagram of selected components of a system for determining a startup engine angle of an internal combustion engine according to the present disclosure;

FIG. 2 is a diagram of one embodiment of the camshaft wheel of FIG. 1 according to the present disclosure;

FIG. 3 is a diagram showing a pulsetrain produced by the sensor of FIG. 1 in response to a camshaft wheel according to the present disclosure; and

FIG. 4 is a flow chart of one embodiment of a method of determining a startup engine angle according to the present disclosure.

### DETAILED DESCRIPTION

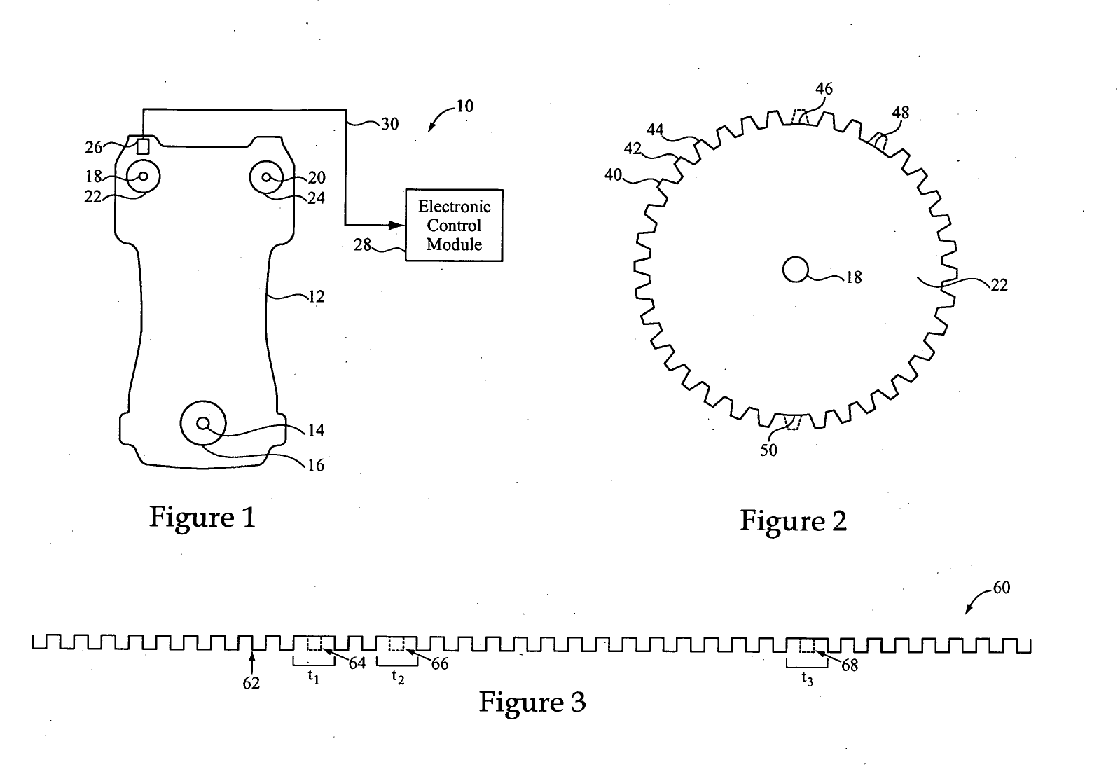

An exemplary embodiment of a system for determining a startup engine angle of an internal combustion engine is shown generally at 10 in FIG. 1. A four-stroke internal combustion engine 12 is shown to generally include a crankshaft 14 having a wheel 16 positioned at an end thereof. The crankshaft 14 is rotatably driven by linear motion of one or more pistons (not shown). The engine 12 also includes one or more camshafts, such as, for example, camshafts 18 and 20, fixed to camshaft wheels 22 and 24, respectively. The camshaft and crankshaft assemblies are geared so that the crankshaft 14 will rotate twice for every one rotation of the camshafts 18 and 20. The camshafts 18 and 20 may be connected to the crankshaft 14 either directly, via a gear mechanism, or indirectly via a belt or chain, such as, for example, a timing belt or timing chain.

The system 10 also includes a sensor 26 placed in close proximity to one of the camshaft wheels, such as, for example, wheel 22. The sensor 26 detects the passage of features or, more specifically, one or more circumferentially spaced teeth extending around the camshaft wheel 22, such as at the perimeter. The sensor 26, as will be appreciated by those skilled in the art, can be of any type, such as, for example, magnetic, opto-electric, Hall effect, high frequency current, or any other similar sensor. The sensor transmits a signal 30, in response to detection of the one or more teeth, to an electronic control module (ECM).

The ECM 28 is of standard design and generally includes a processor, such as, for example, a central processing unit, a memory, and an input/output circuit that facilitates communication internal and external to the ECM. The central processing unit controls operation of the ECM by executing operating instructions, such as, for example, programming code stored in memory, wherein operations may be initiated internally or externally to the ECM. A control scheme may be utilized that monitors outputs of systems or devices, such as, for example, sensors, such as sensor 26, actuators, or control units, via the input/output circuit to control inputs to various other systems or devices. The ECM may also be or include a dedicated circuit that operates in a manner consistent with a counterpart processor executing a specific set of instructions.

The memory may comprise temporary storage areas, such as, for example, cache, virtual memory, or random access memory, or permanent storage areas, such as, for example, read-only memory, removable drives, network/internet storage, hard drives, flash memory, memory sticks, or any other known volatile or non-volatile data storage devices located internally or externally to the ECM. One skilled in the art will appreciate that any computer-based system utilizing similar components is suitable for use with the present disclosure.

The perimeter of the camshaft wheel 22 can be seen in greater detail in FIG. 2. Camshaft wheel 22 includes a plurality of circumferentially spaced teeth, such as, for example teeth 40, 42, and 44, that are spaced at regular intervals. In addition, camshaft wheel 22 includes at least two engine angle indicators, such as, a first engine angle indicator 46, a second engine angle indicator 48, and a third engine angle indicator 50. Each engine angle indicator 46, 48, and 50 may be a missing tooth, an additional tooth, a wider or smaller tooth, a halved or milled tooth, a tooth made from a different material, or any other tooth that is distinct from, but positioned among, the plurality of circumferentially spaced teeth, such as, teeth 40, 42, and 44.

As shown, camshaft wheel 22 includes 36 teeth locations, wherein the plurality of circumferentially spaced teeth, such as teeth 40, 42, and 44, are each located at one of the teeth locations. The engine angle indicators 46, 48, and 50 are missing teeth in the exemplary embodiment, and are also each positioned at one of the teeth locations. Therefore, the camshaft wheel 22 includes 33 teeth and 3 missing teeth along the perimeter thereof, each occupying one of the 36 teeth locations. One skilled in the art will appreciate that any number of teeth locations may be used and that the engine angle indicators may or may not be positioned at teeth locations. For example, if an engine angle indicator is an additional tooth, the indicator may be located between two teeth locations.

Each time a tooth of the camshaft wheel 22, such as, for example, teeth 40, 42, or 44, passes the sensor 26 a pulse is produced. Therefore, during rotation of the camshaft wheel, a series of pulses, or a pulsetrain, is produced having a regular time interval between pulses, except when an engine angle indicator passes by the sensor 26. When a missing tooth, such as, for example, missing tooth 46, passes by the sensor 26 a gap in time is produced that is twice as long as the regular time interval between pulses.

FIG. 3 shows a pulsetrain 60 produced by the sensor 26 in response to one rotation of camshaft wheel 22. Since the camshaft wheel 22 rotates once per a 720 degrees engine cycle, the perimeter of the camshaft wheel is representative of all 720 degrees and will be referenced as having a 720 degrees circumference rather than a 360 degrees circumference. Therefore, pulsetrain 60, representing signals received during one rotation of the camshaft wheel 22, represents all 720 degrees of the engine cycle. Point 62 of the pulsetrain 60 may represent a 0 or 720 degrees engine angle that is indicative of a first piston at top dead center.

Missing teeth 46, 48, and 50, are indicated by time intervals t1, t2, and t3, respectively. Specifically, a point 64 may represent a time period after which a signal was expected. A missing tooth, therefore, is indicated by the ECM 28, and may represent an engine angle of 50 degrees, wherein 50 degrees indicates a unique engine configuration. A second missing tooth may further be indicated at point 66 and may represent an engine angle of 110 degrees. A third missing tooth may be indicated at point 68 and may represent a 410 degrees engine angle. The degrees of 110 and 410 also indicate unique engine configurations.

Although specific engine angles are given, it should be appreciated that two or more engine angle indicators may be positioned along the camshaft wheel 22 to represent various other engine angles. The three specific engine angles represented are chosen merely as examples.

### INDUSTRIAL APPLICABILITY

Referring to FIGS. 1-4, an electronically controlled fuel injection engine, such as engine 12, typically utilizes an electronic control module (ECM), such as ECM 28, to control fuel injection to each cylinder of the engine. The ECM, therefore, needs to know the stroke of each cylinder of the engine to properly control fuel injection and ignition. During engine starting, the ECM must acquire this startup engine angle information before beginning injection.

Typically, the startup engine angle is acquired using crankshaft position information. The crankshaft position information is typically produced using a toothed wheel with at least one angle indicator on the perimeter thereof. The ECM can determine the startup angle of the engine based on the location of the angle indicator. However, since the crankshaft rotates twice per engine cycle, the startup engine angle can only be determined to one of two possibilities. To determine the unique startup engine angle, additional information is used. Typically, information from the camshaft is used to assist in determining this startup angle.

Since the ECM waits for this information to begin fuel injection and, thereafter, ignition, it requires a certain amount of time from when starting is initiated to when the engine begins running on its own. It typically takes at least two engine revolutions before this occurs, which leads to increased starting time and decreased customer satisfaction.

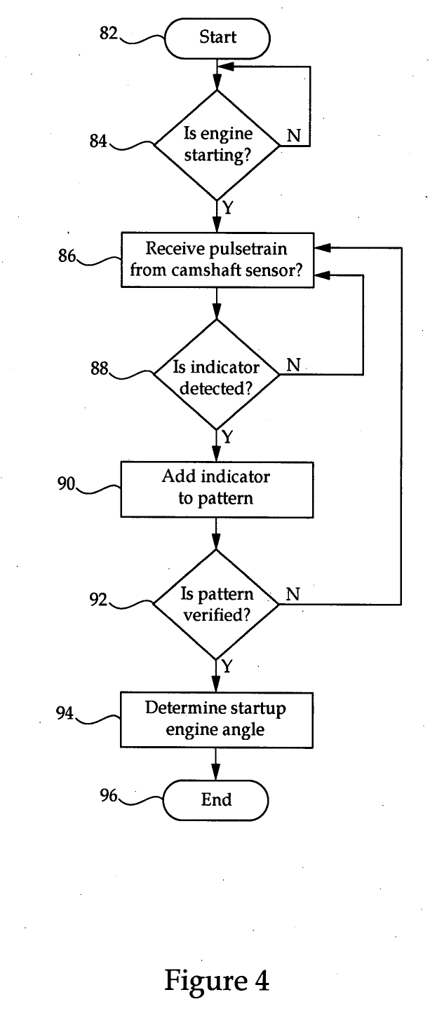

The camshaft wheel 22 and method of the present disclosure may be utilized to more quickly determine the startup angle of the engine and, therefore, decrease engine start time. A flow chart 80 representing a method of determining the startup angle of engine 12 is shown generally in FIG. 4. The method begins at a START, Box 82. From Box 82, the method may proceed to Box 84, which includes the step of determining if the engine 12 is in a starting position. A starting position refers to a time between an initiation of the starting process, such as an operator actuating an ignition switch to begin rotating the engine 12 via some starter mechanism such as an electric motor, and a running of the engine on its own. The ECM 28 is configured to detect such a position, and the method does not continue until such a time occurs.

If the engine 12 is starting, the method proceeds to Box 86, where the ECM 28 receives a pulsetrain, such as, for example, pulsetrain 60, from the camshaft sensor 26. At Box 88 the ECM 28 interprets the pulsetrain 60 to detect a first engine angle indicator, such as, for example, first engine angle indicator 46. Specifically, the ECM 28 is configured to expect signals or pulses of the pulsetrain 60 at regular intervals based upon a timing device of the ECM. Point 64, representing a time period after which a signal was expected, indicates a missing tooth, specifically first engine angle indicator 46. If only one engine angle indicator is positioned along the camshaft wheel 22, when it is detected the engine startup angle ideally could be determined. However, because of the speed at which the camshaft wheel is rotated and the harsh environments in which some engines may operate, it is possible that pulsetrain 60 may be interrupted and a false missing tooth or false extra tooth may be observed. Therefore, a more reliable startup engine angle can be determined using at least two engine angle indicators.

Once an engine angle indicator is detected, such as engine angle indicator 46, the method proceeds to Box 90, where the detected indicator is added to a pattern. At Box 92, the ECM 28 determines if the pattern is verified. This requires a determination of whether two or more engine angle indicators have been detected, and whether they were received at expected or known intervals. If the pattern is not verified, the method returns to Box 86 and the ECM 28 continues to receive and interpret the pulsetrain 60. If, however, the pattern is verified, the method proceeds to Box 94. Since only one engine angle indicator has been detected, the method continues until a second engine angle indicator is detected. It is desirable that at least one of the plurality of circumferentially spaced teeth is positioned between engine angle indicators to allow for more reliable detection.

After indicating a second engine angle indicator, such as indicator 46, at point 66 the method proceeds again to Box 92, where it is determined whether or not the pattern is verified. If the ECM 28 is configured to expect indications of missing teeth at 50 degrees and 110 degrees, the ECM can determine that those engine indicators have been properly detected if the time lapse between detection of the indicators represents 60 degrees.

The second engine angle indicator 48, or, more specifically, the timing separation between detection of the first and second indicators 46 and 48, provides verification that both the first engine angle indicator and the second engine angle indicator were properly detected. The method then proceeds to Box 94, where the ECM 28 determines the startup angle of the engine 12 based on the pattern. If two engine angle indicators are used, one positioned to represent a 50 degrees engine angle and one positioned to represent a 110 degrees engine angle, detecting two engine angle indicators 60 degrees apart provides a verified indication that the engine, at point 66, is at 110 degrees. The ECM 28 uses this information to determine the unique engine configuration at that time. The method then proceeds to an END, box 96. After determining the engine startup angle, the ECM 28 may properly initiate sequential fuel injection.

Utilizing a third engine angle indicator, such as indicator 50, provides additional verification. For example, the ECM 28 may be configured to require indication of three engine angle indicators at two known time intervals before determining the startup engine angle. If point 68 indicates engine angle indicator 50 and indicator 50 is positioned to represent a 410 degrees engine angle, the ECM can determine the startup engine angle after detecting the second engine angle indicator 60 degrees after the first engine angle indicator and the third engine angle indicator 300 degrees after the second engine angle indicator.

One skilled in the art will appreciate that any number of engine angle indicators may be positioned along camshaft wheel 22, as long as they are positioned at unique intervals. In addition, the ECM 28 may be configured to determine the startup engine angle after any desired number of engine angle indicators have been detected. The method, thus, allows for detection and verification of the startup engine angle in less than one rotation of the camshaft wheel 22, and as quickly as after detection of the second engine angle indicator.

In addition to determining the startup engine angle of the engine 12, the camshaft wheel 22 may also be used to detect a reverse running direction of the engine. A reverse running direction of an engine may occur when the engine is stopped while in a process of starting. The ECM 28 may be further configured to recognize a reverse pattern of indicated missing teeth, in a manner similar to that described above, to determine a reverse running direction of the engine.

It should be understood that the above description is intended for illustrative purposes only, and is not intended to limit the scope of the present invention in any way. Thus, those skilled in the art will appreciate that other aspects of the invention can be obtained from a study of the drawings, the disclosure and the appended claims.

1. A machine having an internal combustion engine, comprising:
a camshaft wheel rotatably driven by a crankshaft of the engine, wherein the camshaft wheel includes a plurality of circumferentially spaced teeth;
a first engine angle indicator positioned among the circumferentially spaced teeth of the camshaft wheel, wherein the first engine angle indicator is one of a missing tooth and an additional tooth;
a second engine angle indicator positioned among the circumferentially spaced teeth of the camshaft wheel less than about 90 degrees from the first engine angle indicator, wherein the second engine angle indicator is one of a missing tooth and an additional tooth;
a camshaft wheel sensor for producing a pulsetrain in response to detection of the plurality of circumferentially spaced teeth and additional teeth; and
an electronic control module configured to determine a location of the first engine angle indicator and the second engine angle indicator based on the pulsetrain, and determine a startup engine angle based on a timing separation between features of the pulsetrain.

2. The machine of claim 1, wherein the second engine angle indicator is positioned about 30 degrees from the first engine angle indicator.

3. The machine of claim 1, wherein at least one of the circumferentially spaced teeth is positioned between the first engine angle indicator and the second engine angle indicator.

4. The machine of claim 1, further including a third engine angle indicator positioned among the circumferentially spaced teeth of the camshaft wheel, wherein the third engine angle indicator is one of a missing tooth and an additional tooth.

5. The machine of claim 4, wherein the third engine angle indicator is positioned about 180 degrees from the first engine angle indicator.

6. The machine of claim 5, wherein the electronic control module is further configured to:
determine a location of the third engine angle indicator based on the pulsetrain.

7. The machine of claim 6, wherein the electronic control module is further configured to detect a reverse running condition of the engine based on the timing separation between features of the pulsetrain.

8. The machine of claim 1, wherein the camshaft wheel includes at least 24 equidistantly spaced teeth locations adjacent a perimeter thereof.

9. The machine of claim 1, wherein the camshaft wheel includes at least 36 equidistantly spaced teeth locations adjacent a perimeter thereof.

10. The machine of claim 9, wherein the first engine angle indicator and the second engine angle indicator are missing teeth.

11. The machine of claim 1, wherein the startup engine angle is one of 720 degrees of one engine cycle, wherein each of the 720 degrees is represented by a location along a perimeter of the camshaft wheel.

12. The machine of claim 11, wherein the electronic control module is further configured to transition the machine from an engine angle determination phase to an injection phase in less than half a rotation of the camshaft wheel.

13. A method of starting an internal combustion engine of a machine, comprising:
rotating the engine prior to combustion;
producing a pulsetrain in response to detection of a plurality of circumferentially spaced teeth around a perimeter of a camshaft wheel using a camshaft wheel sensor, wherein the camshaft wheel is rotatably driven by a crankshaft of the engine;
identifying a first engine angle indicator and a second engine angle indicator from the pulsetrain, wherein each of the first engine angle indicator and the second engine angle indicator is one of a missing tooth and an additional tooth, and wherein the second engine angle indicator is positioned among the circumferentially spaced teeth of the camshaft wheel less than about 90 degrees from the first engine angle indicator; and
determining the startup angle of the engine, using an electronic control module, based on a timing separation between features of the pulsetrain.

14. The method of claim 13, further including beginning sequential fuel injection to the engine after the determining step and before the camshaft wheel has completed half a rotation.

15. The method of claim 13, further including:
identifying a third engine angle indicator from the pulsetrain.

16. The method of claim 15, further including:
detecting a reverse running condition of the engine based on the timing separation between features of the pulsetrain.

17. The method of claim 13, wherein the determining step further includes comparing the features to a pattern stored in memory.

18. A camshaft wheel for an internal combustion engine, comprising:
a circular wheel having 36 equidistantly spaced teeth locations, wherein the wheel is rotatably driven by a crankshaft of the engine and includes at least 33 circumferentially spaced teeth;
a first missing tooth positioned among the spaced teeth locations of the wheel;
a second missing tooth positioned among the spaced teeth locations of the wheel less than about 90 degrees from the first missing tooth;
wherein at least one tooth is positioned between the first missing tooth and the second missing tooth;
a wheel sensor for producing a pulsetrain in response to detection of the circumferentially spaced teeth; and
an electronic control module configured to determine a location of the first missing tooth and the second missing tooth based on the pulsetrain, and determine a startup engine angle based on a timing separation between features of the pulsetrain.

19. The camshaft wheel of claim 18, further including a third missing tooth positioned among the spaced teeth locations of the wheel.

20. The camshaft wheel of claim 19, wherein the third missing tooth is positioned about 180 degrees from the first missing tooth.
